(19) United States
(12) Patent Application Publication
(10) Pub. No.: US 2026/0012046 A1
(43) Pub. Date: Jan. 8, 2026

(54) MOTOR WITH POLYMERIC MATERIAL ROTOR AND/OR STATOR SLEEVE

(71) Applicant: VICTREX MANUFACTURING LIMITED, Thornton Cleveleys, Lancashire (GB)

(72) Inventors: Joseph Elmquist, Thornton Cleveleys, Lancashire (GB); Peter Levesque, Thornton Cleveleys, Lancashire (GB)

(21) Appl. No.: 19/105,284

(22) PCT Filed: Aug. 21, 2023
(86) PCT No.: PCT/GB2023/052176

§ 371 Date: Feb. 20, 2025

(30) Foreign Application Priority Data
Aug. 22, 2022 (GB) 2212206.3

(51) Int. Cl. H02K 1/04; C08J 5/04; H02K 1/16; H02K 1/276; H02K 15/121; H02K 21/14

(52) U.S. Cl. CPC H02K 1/04; C08J 5/042; H02K 1/16; H02K 1/276; H02K 15/121; H02K 21/14; C08J 2371/08; H02K 2201/03

(57) ABSTRACT

The invention relates to: a rotor for an electric motor, wherein the rotor comprises a rotor core and a rotor sleeve which circumferentially encloses the rotor core, wherein the rotor core comprises one or more magnets, wherein the rotor sleeve comprises a plastic and fibres, wherein the fibres have a tensile strength greater than or equal to 4440 MPa. The invention also relates to: a stator for an electric motor comprising a gap pipe, wherein the gap pipe comprises a plastic and fibres, wherein the fibres have a tensile strength greater than or equal to 4440 MPa and dry fibre tensile modulus in the range of 200 to 450 GPa. The rotor and stator may be used in an electric motor assembly, preferably for a vehicle. The use of a gap pipe and/or a rotor sleeve according to the invention can reduce the air gap. This results in an improvement to the overall motor efficiency and performance.

### FIELD OF THE INVENTION

The invention relates to a rotor for an electric motor comprising a rotor sleeve and a stator for an electric motor comprising a gap pipe. The rotor and stator for an electric motor may be used in the automotive industry.

### BACKGROUND OF THE INVENTION

Electric motors typically contain a moving rotor and a stator core. In rotors comprising magnetised components, such as permanent magnets, the physical distance between the electromagnetic components of the rotor and the stator is known as the air gap. The air gap is an essential requirement for the motor to function. The air gap exists to allow the rotor to freely rotate across all use conditions and prevents contact between the rotor and stator. If the air gap is too small, the rotating rotor and stator will come into contact during operation, for example due to deflection, resulting in motor failure. However, the air gap needs to be as small as possible to maximise the strength of the magnetic circuit. Therefore, the wider the air gap the lower the efficiency and performance of the motor.

Since the size of the air gap in an electric motor is intrinsically linked to motor performance, it is highly desirable to achieve as small an air gap as reliably as possible across all operating and manufacturing variables.

Electric motors may contain gap pipes and rotor sleeves.

A rotor sleeve is an optional component of a rotor. A rotor may consist of several components such as permanent magnets, poles of electrically conductive steel and yoke of the same material. For optimal motor performance the magnets in the rotor must be physically constrained in such a way as to optimize mechanical retention and electromagnetic field structure. In a common configuration, the rotor components are retained with a rotor sleeve made of a non-electromagnetic material which maintains rotor structural integrity in spite of high centripetal forces.

A gap pipe is an optional component of a stator. It is typical for motors to contact oil or a cooling fluid onto the hot areas (primarily conductors in the stator). One challenge of having an oil or cooling fluid circulating across large areas of the stator assembly is the proximity of the high-speed rotating electrical steel rotor. This could cause significant hydrodynamic losses on the rotor and make it more challenging to control the contact/residency time of the fluid at the surface of hot conductors in the stator, without some sort of separating and sealing component. A gap pipe may be used as this separating and sealing component.

DE102019207078 A1 discloses a can arranged between the rotor and stator of an electric machine. The purpose of the can is to hermetically separate the rotor and stator from one another and reduce the magnetic losses in the air gap between the rotor and stator. The can is made from a composite material such as thermosetting plastics.

WO 2011/099603 A1 discloses a canned electric motor comprising a can composed of a single layer of fibre-reinforced plastics comprising one resin of poly ether ether ketone (PEEK), polyamide (PI) polyester amide imide, polyhydantoin, isocyanurate denatured polyester imide, polyamideimide, polyester and epoxide, which is reinforced with carbon fiber or glass fiber or aramid fiber. The purpose of the can is to separate the stator and the rotor.

EP2348614 A1 discloses a rotor comprising peripheral active elements and a binding band surrounding the peripheral active elements. The binding band is in the form of a cylindrical sleeve and comprises polyetheretherketone (PEEK) reinforced with glass fibres, carbon fibres or poly-para-phenylene terephthalamide fibres. The purpose of the binding band is to provide excellent retention of the peripheral active elements.

U.S. Pat. No. 5,900,689 A discloses a binding for winding overhangs of rotors of electric machines, comprising a plastic matrix with fibrous material embedded therein, said binding having been formed by winding a fiber tape onto said winding overhang, wherein said plastic matrix is a thermoplastic.

There is a need for an electric motor in which the air gap has been reduced and efficiency and performance of the motor improved.

### SUMMARY OF THE INVENTION

In certain electric motors, it is essential to have a rotor sleeve and/or a gap pipe. In such electric motors, the inventors of the present invention surprisingly found that use of a gap pipe and/or a rotor sleeve according to the invention can reduce the air gap. This results in an improvement to the overall motor efficiency and performance.

In particular, the inventors surprisingly discovered that the use of a plastic gap pipe and/or rotor sleeve reinforced with fibres having a specific tensile strength and/or dry tensile modulus resulted in a reduced air gap. This is demonstrated in the examples section below.

The rotor comprising a rotor sleeve as described herein further enables higher rotor speeds, higher rotor temperatures, improved reliability, improved manufacturing efficiency and safety, and/or improved manufactured robustness, and improved recyclability.

The gap pipe according to the invention allows for improved cooling performance resulting in higher continuous power density, torque, and/or efficiency for a given rotor and stator configuration. Additionally, during manufacturing trials of the rotor sleeve and gap pipe described herein it was found that the invention could further improve manufacturing efficiency and productivity by consuming less material and energy, and/or improve material recyclability.

According to a first aspect of the invention, there is provided a rotor for an electric motor, wherein the rotor comprises a rotor core and a rotor sleeve which circumferentially encloses the rotor core, wherein the rotor core comprises one or more magnets, wherein the rotor sleeve comprises a plastic and fibres, wherein the fibres have a tensile strength greater than or equal to 4440 MPa.

According to a second aspect of the invention, there is provided a method for producing a rotor comprising a rotor core and a rotor sleeve, the method comprising the steps of:
providing a rotor core comprising one or more magnets;
providing a material comprising a plastic and fibres, wherein the fibres have a tensile strength greater than or equal to 4440 MPa;
winding the material around the rotor core such that the material is tensioned and forms a rotor sleeve which circumferentially encloses the rotor core.

According to a third aspect of the invention, there is provided a stator for an electric motor comprising a gap pipe, wherein the gap pipe comprises a plastic and fibres, wherein the fibres have a tensile strength greater than or equal to 4440 MPa and dry fibre tensile modulus in the range of 200 to 450 GPa.

According to a fourth aspect of the invention, there is provided a method for producing a stator comprising laminations and a gap pipe, the method comprising the steps of:
(i) providing a stator comprising laminations;
(ii) providing a gap pipe comprising a plastic and fibres, wherein the fibres have a tensile strength greater than or equal to 4440 MPa and dry fibre tensile modulus in the range of 200 to 450 GPa; and
(iii) mechanically adhering the gap pipe to the stator laminations.

According to a fifth aspect of the invention, there is provided an electric motor assembly comprising;
a rotor comprising a rotor core and a rotor sleeve which circumferentially encloses the rotor core, wherein the rotor core comprises one or more magnets, wherein the rotor sleeve comprises a plastic and fibres, wherein the fibres have a tensile strength greater than or equal to 4440 MPa; and
a stator comprising a gap pipe, wherein the gap pipe comprises a plastic and fibres, wherein the fibres have a tensile strength greater than or equal 4440 MPa and dry fibre tensile modulus in the range of 200 to 450 GPa;
and wherein an air gap is provided between the rotor sleeve and the gap pipe.

According to a sixth aspect of the invention, there is provided a vehicle comprising the assembly described above.

### FIGURES

FIG. 1 shows a cross section of an electric motor comprises a rotor and stator according to one embodiment of the invention.

FIG. 2 shows a cross section of an electric motor comprises a rotor and stator according to one embodiment of the invention.

FIG. 3 shows a side view of an electric motor comprises a rotor and stator according to one embodiment of the invention.

FIG. 4 shows a face on view of an electric motor comprises a rotor and stator according to one embodiment of the invention.

### DETAILED DESCRIPTION OF THE INVENTION

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention. The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and may also be taken to include the meaning “consists of” or “consisting of”.

The optional and/or preferred features set out herein may be used either individually or in combination with each other where appropriate and particularly in the combinations as set out in the accompanying claims. The optional and/or preferred features for each aspect or exemplary embodiment of the invention, as set out herein are also applicable to any other aspects or exemplary embodiments of the invention, where appropriate. In other words, the skilled person reading this specification should consider the optional and/or preferred features for each aspect or exemplary embodiment of the invention as interchangeable and combinable between different aspects or exemplary embodiments.

### Rotor

In a first aspect of the invention, there is provided a rotor for an electric motor, wherein the rotor comprises a rotor core and a rotor sleeve which circumferentially encloses the rotor core, wherein the rotor core comprises one or more magnets, wherein the rotor sleeve comprises a plastic and fibres, wherein the fibres have a tensile strength greater than or equal to 4440 MPa.

One configuration of an electric motor comprises a stator and a rotor. The term rotor has its usual meaning in the art. A rotor is the rotating part of an electric motor that transfers power. The rotor comprises a core comprising one or more magnets. The magnets may be permanent magnets. In one embodiment, the rotor core may comprise a plurality of permanent magnets, a plurality of poles of electrically conductive material and a yoke of electrically conductive material. In this embodiment the constitutive components of the rotor core are fastened and retained in assembly by a compressive rotor sleeve whereby an air pocket is retained beyond the magnet between the pole and yoke thereby eliminating electromagnetic eddy currents that can occur in other common rotor embodiments.

The rotor according to the present invention comprises a rotor sleeve. The term rotor sleeve has its usual meaning in the art. As the rotor rotates in use, the active elements, such as the magnets, are subjected to high centrifugal forces. For optimal motor performance, the magnets in the rotor must be physically constrained in such a way as to optimise mechanical retention and electromagnetic field structure. A rotor sleeve fully circumferentially surrounds and physically constrains the rotor core comprising one or more magnets to optimize mechanical retention and electromagnetic field structure. In practice, the mechanical retention means that the yoke, poles, and magnet components maintain physical contact across all operating conditions.

The rotor sleeve comprises a plastic and fibres. The rotor sleeve may comprise a plastic matrix with fibres embedded therein. The plastic may be a thermosetting plastic or a thermoplastic or a mixture thereof. Preferably, the plastic is a thermoplastic. A thermoplastic is advantageous as it is easier to process and recycle; results in higher pretension, higher toughness and lower void content which means the rotor sleeve is more structurally sound.

In one embodiment, the thermoplastic may be selected from polyaryletherketones (PAEK), such as polyetheretherketone (PEEK) or polyetherketoneketone (PEKK), polyphenylene sulphide (PPS), polyetherimide (PEI), polycarbonate (PC), polyethylene terephthalate (PET), polyamide (PA), poly (methyl methacrylate) or mixtures thereof.

Preferably, the plastic is a thermoplastic that comprises a polyaryletherketone (PAEK), such as polyetheretherketone (PEEK). PAEKs are advantageous because of their high temperature and chemical resistance, and low permeability.

In particular, the PAEK may comprise a repeat unit of formula:

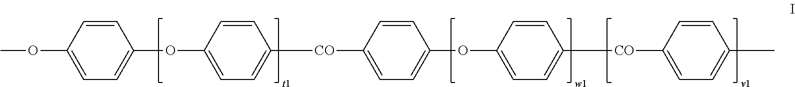

wherein t1 and w1 independently represent 0 or 1 and v1 represents 0, 1 or 2.

Preferred PAEKs have a repeat unit wherein t1=1, v1=0 and w1=0; t1=0, v1=0 and w1=0; t1=0, w1=1, v1=2; or t1=0, v1=1 and w1=0. More preferred PAEKs have a repeat unit wherein t1=1, v1=0 and w1-0; or t1=0, v1=0 and w1=0. The most preferred has a repeat unit wherein t1 =1, v1=0 and w1=0.

In preferred embodiments, the PAEK is selected from polyetheretherketone, polyetherketone, polyetherketoneetherketoneketone and/or polyetherketoneketone, and/or a copolymer including polyetheretherketone and polyetherdiphenyletherketone. In a more preferred embodiment, the PAEK is selected from polyetherketone and/or polyetheretherketone, and/or a copolymer including polyetheretherketone and polyetherdiphenyletherketone. In an especially preferred embodiment, the PAEK is selected from polyetheretherketone, and/or a copolymer including polyetheretherketone and polyetherdiphenyletherketone.

The PAEK suitably includes at least 50 mol %, (e.g. 50-99.8 mol %), preferably at least 60 mol % (e.g. 60-100 mol %), more preferably at least 68 mol % (e.g. 68 to 100 mol %), of repeat units of formula I, especially such units where t1=1, v1=0 and w1=0. In an especially preferred embodiment, the PAEK includes at least 90 mol %, preferably at least 95 mol %, more preferably at least 98 mol %, especially at least 99 mol % of repeat units of formula I, especially repeat units of formula I wherein t1=1, v1=0 and w1=0. Other repeat units in the PAEK may be different repeat units of formula I or may include —Ph—Ph— moieties where Ph represents an unsubstituted phenylene moiety (especially wherein both —Ph— moieties are linked to each other and to adjacent repeat units at the 4,4′ positions-). Other repeat units may include Ph moieties bonded to two moieties selected from carbonyl moieties and ether moieties and —Ph—Ph— moieties bonded to two ether moieties.

The PAEK may be a copolymer which comprises a first moiety of formula I and a second moiety which includes —Ph—Ph— moieties where Ph represents an unsubstituted phenylene moiety (which suitably includes 4,4′ bonds to adjacent moieties).

In one embodiment, the PAEK may be selected from: a polymer comprising at least 98 mol % of a repeat unit of formula I, especially such units wherein t1=1, v1=0 and w1=0; and a copolymer which includes a repeat unit of formula

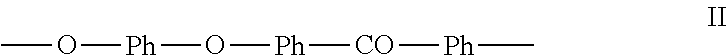

and a repeat unit of formula

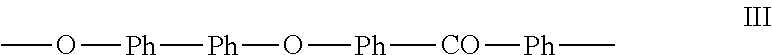

wherein Ph represents a phenylene moiety. Preferably the repeat units of the copolymer consist essentially of the repeat units II and III.

In a preferred embodiment, the PAEK is homopolymer polyetheretherketone, PEEK, with repeat units consisting of formula II:

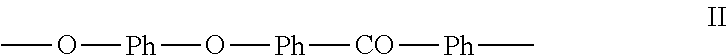

or is a copolymer with repeat units consisting repeat units of formula Il and repeat units of formula III:

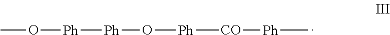

The ends of the polymer may be provided by the same monomers as the monomers making up the repeat units or may be provided by other compounds specifically added to provide end-capping.

The PAEK may preferably comprise at least 98 mole % (e.g. 98 to 99.9 mole %) of a repeat unit of formula I or a copolymer which includes repeat units of formulae II and III.

In the copolymer, the repeat units II and III are preferably in the relative molar proportions VI: VII of from 50:50 to 95:5, more preferably from 60:40 to 95:5, even more preferably from 65:35 to 95:5.

The phenylene moieties (Ph) in each repeat unit II and III may independently have 1,4-para linkages to atoms to which they are bonded or 1,3-meta linkages. Where a phenylene moiety includes 1,3-linkages, the moiety will be in the amorphous phase of the polymer. Crystalline phases will include phenylene moieties with 1,4-linkages. It is generally preferred for the PAEK or PEEK to be semi-crystalline, for instance having a crystallinity of about 25 to 35% and, accordingly, the PAEK or PEEK preferably includes high levels of phenylene moieties with 1,4-linkages.

In a preferred embodiment, at least 95%, preferably at least 99%, of the number of phenylene moieties (Ph) in the repeat unit of formula II have 1,4-linkages to moieties to which they are bonded. It is especially preferred that each phenylene moiety in the repeat unit of formula Il has 1,4-linkages to moieties to which it is bonded.

In a preferred embodiment, at least 95%, preferably at least 99%, of the number of phenylene moieties (Ph) in the repeat unit of formula III have 1,4-linkages to moieties to which they are bonded. It is especially preferred that each phenylene moiety in the repeat unit of formula III has 1,4-linkages to moieties to which it is bonded.

Preferably, the phenylene moieties in the repeat unit of formula II are unsubstituted. Preferably, the phenylene moieties in the repeat unit of formula III are unsubstituted.

The repeat unit of formula Il preferably has the structure:

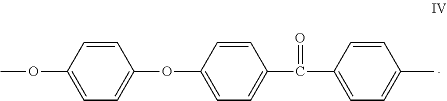

The repeat unit of formula III preferably has the structure:

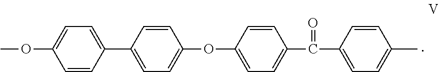

The copolymer may include at least 50 mol %, preferably at least 60 mol % of repeat units of formula IV. Particular advantageous copolymers may include at least 62 mol %, or, especially, at least 64 mol % of repeat units of formula IV. The copolymer may include less than 90 mol %, suitably 82mol % or less of repeat units of formula IV. The copolymer may include 58 to 82 mol %, preferably 60 to 80 mol %, more preferably 62 to 77 mol % of units of formula IV.

The copolymer may include at least 10 mol %, preferably at least 18 mol %, of repeat units of formula V. The copolymer may include less than 42 mol %, preferably less than 39 mol % of repeat units of formula V. Particularly advantageous copolymers may include 38 mol % or less; or 36 mol % or less of repeat units of formula V. The copolymer may include 18 to 42 mol %, preferably 20 to 40 mol %, more preferably 23 to 38 mol % of units of formula V.

The sum of the mol % of units of formula IV and V in the copolymer is suitably at least 95 mol %, is preferably at least 98 mol %, is more preferably at least 99 mol %.

In one embodiment, the rotor sleeve may be formed of the plastic and fibres.

The plastic may comprise optional fillers or additives.

The rotor sleeve comprises fibres having a tensile strength greater than or equal to 4440 MPa. The inventors have discovered that the use of fibres having this tensile strength results in a reduction in the operational air gap of the electric motor. This is demonstrated in the examples below. A reduction in the air gap is extremely beneficial as it improves motor efficiency.

In one embodiment, the fibres have a tensile strength greater than or equal to 5000 MPa, more preferably greater than or equal to 5500 MPa, more preferably greater than or equal to 6000 MPa, more preferably greater than or equal to 6500 MPa. In one embodiment, the fibres have a tensile strength of less than or equal to 10000 MPa, preferably less than or equal to 9000 MPa, preferably less than or equal to 8000 MPa, preferably less than or equal to 7000 MPa. It has been found that using a rotor sleeve comprising fibres having a tensile strength in this range results in a reduction of the air gap in the electric motor.

In one embodiment, the fibres are selected from carbon fibres, aramid fibres or glass fibres. Preferably, the fibres are carbon fibres.

In one embodiment, the fibres have a dry fibre tensile modulus in the range of 200 to 450 GPa, preferably 240 to 350 GPa. It has been found that a rotor sleeve comprising fibres with a tensile modulus in this range results in a reduction of the air gap in an electric motor. This is thought to be, in part, because the pre-tension of the rotor sleeve can be increased, which results in a more rigid rotor sleeve. The more rigid rotor sleeve can therefore be thinner, resulting in a reduced air gap.

In one embodiment, the rotor sleeve comprises fibres having a dry fibre tensile modulus of 276 GPa and/or a tensile strength of 5600 MPa,

In one embodiment, the rotor sleeve comprises fibres having a dry fibre tensile modulus of 313 GPa and/or a tensile strength of 6800 MPa.

The tensile strength of fibres may be measured in accordance with ISO 11566.

The dry fibre tensile modulus may be measured in accordance with ISO 11566.

Commercially available fibres which may be used in the rotor sleeve include IM7 (Hexcel), IM10 (Hexcel), T1100 (Toray) and AS4 (Hexcel).

In one embodiment, the rotor sleeve comprises between 30 and 70% by volume of fibre, more preferably between 40 and 60% by volume of fibre. The inventors have found that this volume of fibres results in a rotor sleeve that has optimal strength, whilst ensuring that the plastic matrix maintains structural integrity.

In one embodiment, the rotor sleeve has a thickness of less than 2.5 mm, preferably between 0.3 and 1.8 mm. The rotor sleeve may have a thickness between 0.4 and 1.5 mm. The inventors have discovered that by using a rotor sleeve comprising a plastic and fibres as described herein, it is possible to obtain a thinner, more rigid rotor sleeve. Rotor sleeves made from different materials are required to be thicker in order to ensure that the rotor components are constrained during rotation.

In one embodiment, the rotor sleeve may comprise one or more layers. The one or more layers may be formed of a composite tape. By this, it is meant that the plastic forms a matrix in which is the fibres are embedded. The fibres may be continuous fibres. The tape may be a unidirectional tape.

In one embodiment, the rotor sleeve has a tensile modulus of between 45 and 400 GPa, more preferably between 65 and 360 GPa. The tensile modulus of the rotor sleeve lamination may be measured in accordance with ISO 527. It has been found that a rotor sleeve having a tensile modulus in this range results in a reduced air gap.

In one embodiment, the plastic may comprise a filler or an additive to enhance mechanical properties or electromagnetic performance or to deliver added functionality (e.g. Barium sulphate).

In one embodiment, the rotor sleeve comprises a magnetic filler. This improves magnetic flux behaviour which improves motor efficiency.

The rotor sleeve may comprise one or more sensors. The one or more sensors may be embedded in the rotor sleeve. The sensor may be used for measuring performance such as temperature, strain, pressure, leak detection or air gap monitoring. The sensors may be piezoelectric sensors.

The rotor sleeve may be adapted to enhance motor cooling. The rotor sleeve may comprise one or more cooling channels. The rotor sleeve may comprise one or more Peltier elements.

In one embodiment, the rotor sleeve has a pre-tension between 10% and 60%, preferably between 20% and 40%, more preferably 35% of the rotor sleeve tensile strength. Pre-tension compresses the rotor core such that normal operating speeds the centripetal loading relaxes the magnet contact interfaces rather than causing separation of the magnet, yoke, and poles. Additionally, the pre-tension must not be so high as to cause rotor sleeve failure at maximum rotor speed as pre-tension and centripetal loading are additive.

In a further aspect of the invention, there is provided a method for producing a rotor comprising rotor core and a rotor sleeve, the method comprising the steps of:
providing a rotor core comprising one or more magnets;
providing a material comprising a plastic and fibres, wherein the fibres have a tensile strength greater than or equal to 4440 MPa;
winding the material around the rotor core such that the material is tensioned and forms a rotor sleeve which circumferentially encloses the rotor core.

The rotor in this method may have any of the preferred features described above.

In this method, the rotor sleeve is manufactured directly on the rotor components (i.e. the rotor core and one or more magnets). The rotor components may have been glued together for the assembly process. Alternatively, the rotor components may not have been glued together.

In one embodiment, the material is pre-tensioned to compress the rotor core.

In one embodiment, the material may be a fibre, filament, tape, sheet or ribbon. Preferably, it is a tape. The fibres may be continuous fibres. The tape may be a unidirectional tape.

In one embodiment, the one or more magnets may be magnetised prior to assembly of the rotor. Alternatively, the one or more magnets may be magnetised after the rotor has been assembled. This has the associated benefit of increased processing temperature exposure.

In a further aspect of the invention, there is provided use of a rotor sleeve to reduce the air gap in an electric motor comprising a rotor and a stator, wherein the rotor and stator are as described herein.

### Stator

In one aspect of the invention, there is provided a stator for an electric motor comprising a gap pipe, wherein the gap pipe comprises a plastic and fibres, wherein the fibres have a tensile strength greater than or equal to 4440 MPa and a dry fibre tensile modulus in the range of 200 to 450 GPa.

One configuration of an electric motor comprises a stator and a rotor. The term stator has its usual meaning in the art. The stator is a stationary part of an electric motor. The stator may comprise one or more stator windings and one or more stator laminations. The stator comprises a gap pipe. The gap pipe is a separating component that provides a seal between the stator and the rotor, by preventing oil/cooling fluid circulating across large areas of the stator assembly from coming into contact with the high-speed rotating electrical rotor.

The gap pipe comprises a plastic and fibres. The gap pipe may comprise a plastic matrix with fibres embedded therein. The plastic may be a thermosetting plastic or a thermoplastic or a mixture thereof. Preferably, the plastic is a thermoplastic. A thermoplastic is advantageous as it is easier to process and recycle; results in higher toughness and lower void content which means the gap pipe is more structurally sound, and less permeable to dielectric fluids. Additionally, during manufacturing trials it was surprisingly found that when the plastic is a polyaryletherketone (PAEK), the gap pipe exhibited lower void content and improved resin distribution thereby enabling a thinner gap pipe without fluid leakage paths which further resulted in improved motor performance, less material, and faster processing.

In one embodiment, the thermoplastic may be selected from polyaryletherketones (PAEK), such as polyetheretherketone (PEEK) or polyetherketoneketone (PEKK), polyphenylene sulphide (PPS), polyetherimide (PEI), polycarbonate (PC), polyethylene terephthalate (PET), polyamide (PA), poly (methyl methacrylate) or mixtures thereof.

Preferably, the plastic is a thermoplastic that comprises a polyaryletherketone (PAEK), such as polyetheretherketone (PEEK). PAEKs are advantageous because of their high temperature and chemical resistance, and low permeability.

In particular, the PAEK may comprise a repeat unit of formula:

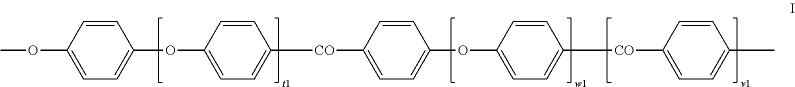

wherein t1 and w1 independently represent 0 or 1 and v1 represents 0, 1 or 2.

Preferred PAEKs have a repeat unit wherein t1=1, v1=0 and w1=0; t1=0, v1=0 and w1=0; t1=0, w1=1, v1=2; or t1=0, v1=1 and w1=0. More preferred PAEKs have a repeat unit wherein t1=1, v1=0 and w1-0; or t1=0, v1=0 and w1=0. The most preferred has a repeat unit wherein t1 =1, v1=0 and w1=0.

In preferred embodiments, the PAEK is selected from polyetheretherketone, polyetherketone, polyetherketoneetherketoneketone and/or polyetherketoneketone, and/or a copolymer including polyetheretherketone and polyetherdiphenyletherketone. In a more preferred embodiment, the PAEK is selected from polyetherketone and/or polyetheretherketone, and/or a copolymer including polyetheretherketone and polyetherdiphenyletherketone. In an especially preferred embodiment, the PAEK is selected from polyetheretherketone, and/or a copolymer including polyetheretherketone and polyetherdiphenyletherketone.

The PAEK suitably includes at least 50 mol %, (e.g. 50-99.8 mol %), preferably at least 60 mol % (e.g. 60-100 mol %), more preferably at least 68 mol % (e.g. 68 to 100 mol %), of repeat units of formula I, especially such units where t1=1, v1=0 and w1=0. In an especially preferred embodiment, the PAEK includes at least 90 mol %, preferably at least 95 mol %, more preferably at least 98 mol %, especially at least 99 mol % of repeat units of formula I, especially repeat units of formula I wherein t1=1, v1=0 and w1=0. Other repeat units in the PAEK may be different repeat units of formula I or may include —Ph—Ph— moieties where Ph represents an unsubstituted phenylene moiety (especially wherein both —Ph— moieties are linked to each other and to adjacent repeat units at the 4,4′ positions-). Other repeat units may include Ph moieties bonded to two moieties selected from carbonyl moieties and ether moieties and —Ph—Ph— moieties bonded to two ether moieties.

The PAEK may be a copolymer which comprises a first moiety of formula I and a second moiety which includes —Ph—Ph— moieties where Ph represents an unsubstituted phenylene moiety (which suitably includes 4,4′ bonds to adjacent moieties).

In one embodiment, the PAEK may be selected from: a polymer comprising at least 98 mol % of a repeat unit of formula I, especially such units wherein t1 =1, v1=0 and w1=0; and a copolymer which includes a repeat unit of formula

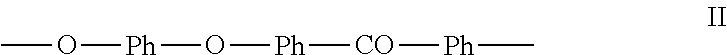

and a repeat unit of formula

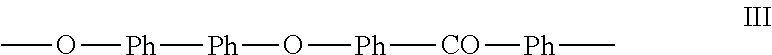

wherein Ph represents a phenylene moiety. Preferably the repeat units of the copolymer consist essentially of the repeat units II and III.

In a preferred embodiment, the PAEK is homopolymer polyetheretherketone, PEEK, with repeat units consisting of formula II:

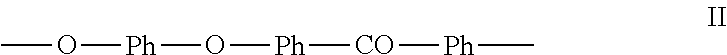

or is a copolymer with repeat units consisting repeat units of formula Il and repeat units of formula III:

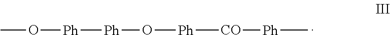

The ends of the polymer may be provided by the same monomers as the monomers making up the repeat units or may be provided by other compounds specifically added to provide end-capping.

The PAEK may preferably comprise at least 98 mole % (e.g. 98 to 99.9 mole %) of a repeat unit of formula I or a copolymer which includes repeat units of formulae II and III.

In the copolymer, the repeat units II and III are preferably in the relative molar proportions VI: VII of from 50:50 to 95:5, more preferably from 60:40 to 95:5, even more preferably from 65:35 to 95:5.

The phenylene moieties (Ph) in each repeat unit II and III may independently have 1,4-para linkages to atoms to which they are bonded or 1,3-meta linkages. Where a phenylene moiety includes 1,3-linkages, the moiety will be in the amorphous phase of the polymer. Crystalline phases will include phenylene moieties with 1,4-linkages. It is generally preferred for the PAEK or PEEK to be semi-crystalline, for instance having a crystallinity of about 25 to 35% and, accordingly, the PAEK or PEEK preferably includes high levels of phenylene moieties with 1,4-linkages.

In a preferred embodiment, at least 95%, preferably at least 99%, of the number of phenylene moieties (Ph) in the repeat unit of formula II have 1,4-linkages to moieties to which they are bonded. It is especially preferred that each phenylene moiety in the repeat unit of formula II has 1,4-linkages to moieties to which it is bonded.

In a preferred embodiment, at least 95%, preferably at least 99%, of the number of phenylene moieties (Ph) in the repeat unit of formula III have 1,4-linkages to moieties to which they are bonded. It is especially preferred that each phenylene moiety in the repeat unit of formula III has 1,4-linkages to moieties to which it is bonded.

Preferably, the phenylene moieties in the repeat unit of formula II are unsubstituted. Preferably, the phenylene moieties in the repeat unit of formula III are unsubstituted.

The repeat unit of formula II preferably has the structure:

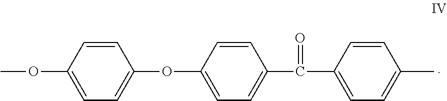

The repeat unit of formula III preferably has the structure:

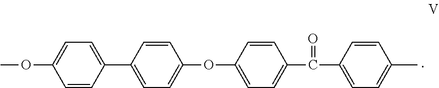

The copolymer may include at least 50 mol %, preferably at least 60 mol % of repeat units of formula IV. Particular advantageous copolymers may include at least 62mol %, or, especially, at least 64 mol % of repeat units of formula IV. The copolymer may include less than 90 mol %, suitably 82mol % or less of repeat units of formula IV. The copolymer may include 58 to 82 mol %, preferably 60 to 80 mol %, more preferably 62 to 77 mol % of units of formula IV.

The copolymer may include at least 10 mol %, preferably at least 18 mol %, of repeat units of formula V. The copolymer may include less than 42 mol %, preferably less than 39 mol % of repeat units of formula V. Particularly advantageous copolymers may include 38 mol % or less; or 36 mol % or less of repeat units of formula V. The copolymer may include 18 to 42 mol %, preferably 20 to 40 mol %, more preferably 23 to 38 mol % of units of formula V.

The sum of the mol % of units of formula IV and V in the copolymer is suitably at least 95 mol %, is preferably at least 98 mol %, is more preferably at least 99 mol %.

In one embodiment, the gap pipe may be formed of the plastic and fibres.

The plastic may comprise optional fillers or additives.

The gap pipe comprises fibres having a tensile strength greater than or equal to 4440 MPa. The inventors have discovered that the use of fibres having this tensile strength results in a reduction in the air gap of the electric motor. This is demonstrated in the examples below. A reduction in the air gap is extremely beneficial as it improves motor efficiency.

In one embodiment, the fibres have a tensile strength greater than or equal to 5000 MPa, more preferably greater than or equal to 5500 MPa, more preferably greater than or equal to 6000 MPa, more preferably greater than or equal to 6500 MPa. In one embodiment, the fibres have a tensile strength of less than or equal to 10000 MPa, preferably less than or equal to 9000 MPa, preferably less than or equal to 8000 MPa, preferably less than or equal to 7000 MPa. It has been found that using a gap pipe comprising fibres having a tensile strength in this range results in a reduction of the air gap in the electric motor. This is because it allows for a thinner gap pipe wall thickness, which enables the air gap to be reduced and motor efficiency to be improved.

In one embodiment, the fibres are selected from carbon fibres, aramid fibres or glass fibres. Preferably, the fibres are carbon fibres.

The gap pipe comprises fibres having a dry fibre tensile modulus in the range of 200 to 450 GPa, preferably 240 to 350 GPa. It has been found that a gap pipe comprising fibres with a tensile modulus in this range results in a reduction of the air gap in an electric motor.

In one embodiment, the gap pipe comprises fibres having a dry fibre tensile modulus of 276 GPa and/or a tensile strength of 5600 MPa,

In one embodiment, the gap pipe comprises fibres having a dry fibre tensile modulus of 313 GPa and/or a tensile strength of 6800 MPa.

The tensile strength of fibres may be measured in accordance with ISO 11566

The dry fibre tensile modulus may be measured in accordance with ISO 11566

Commercially available fibres which may be used in the gap pipe include IM7 (Hexcel), IM10 (Hexcel), T1100 (Toray) and AS4 (Hexcel).

In one embodiment, the gap pipe may comprise between 30 and 70% by volume of fibre, more preferably between 40 and 60% by volume of fibre. The inventors have found that this volume of fibres results in a rotor sleeve that has optimal strength, whilst ensuring that the plastic matrix maintains structural integrity.

In one embodiment, the gap pipe may have a thickness between 0.1 mm and 3 mm, more preferably 0.28 mm to 2.8 mm. The inventors have discovered that by using a gap pipe comprising a plastic and fibres as described herein, it is possible to obtain a thinner gap pipe. Because the gap pipe according to the invention is thinner than existing gap pipes, this results in several advantages. For example, there is improved assembly efficiency and robustness, in part because there is less variability between parts which results in more efficient assembly. Furthermore, there is a reduced environmental footprint because less material is required to make the thinner gape pipe. Using less material also means the manufacturing process is faster resulting in increased manufacturing throughput.

In one embodiment, the gap pipe may comprise one or more layers. The one or more layers may be formed of a composite tape. By this, it is meant that the plastic forms a matrix in which is the fibres are embedded. The fibres may be continuous fibres. The tape may be a unidirectional tape.

In one embodiment, the gap pipe comprises one or more thermoplastic film layers on the exterior and/or interior and/or interlayers. The purpose of this layer is to seal the gap pipe against fluid intrusion.

In one embodiment, the gap pipe has a tensile modulus of between 45 and 400 GPa, more preferably between 65 and 360 GPa. The tensile modulus of the gap pipe may be measured in accordance with ISO 527. It has been found that a gap pipe having a tensile modulus in this range results in a reduced air gap.

The gap pipe may comprise one or more sensors. The one or more sensors may be embedded in the gap pipe. The sensor may be used for measuring performance such as temperature, strain, pressure, leak detection or air gap monitoring. The sensors may be piezoelectric sensors.

The gap pipe may be adapted to enhance stator cooling. The gap pipe may comprise one or more Peltier elements to supplement or replace stator fluid. The gap pipe may comprise conducting fibres aligned axially and in contact on the end with a conducting material to improve cooling.

In one embodiment, the plastic may comprise a filler or an additive to enhance mechanical properties or electromagnetic performance or to deliver added functionality (e.g. Barium sulphate).

In one embodiment, the gap pipe comprises a magnetic filler. This improves magnetic flux behaviour which improves motor efficiency.

In one aspect of the invention, there is provided a method for producing a stator comprising laminations and a gap pipe, the method comprising the steps of:
providing a stator comprising laminations;
providing a gap pipe comprising a plastic and fibres, wherein the fibres have a tensile strength greater than or equal to 4440 MPa and dry fibre tensile modulus in the range of 200 to 450 GPa; and
adhering the gap pipe to the stator laminations.

The stator in this method may have any of the preferred features described above.

The gap pipe may be adhered to the stator lamination by chemical, mechanical or covalent means, or a combination thereof.

There are several advantages to adhering the gap pipe to the stator lamination. Firstly, the fluid pressure is contained to the stator channels reducing the force on the gap pipe due to fluid pressure and enabling the gap pipe to be thinner to achieve the same mechanical performance. Secondly, the gap pipe adhesion to the stator strengthens the gap pipe radially also enabling the gap pipe to be thinner to achieve the same mechanical performance (radial stiffness). Therefore, this method of adhering the gap pipe to the stator laminations further reduces the air gap and improves motor efficiency, as it allows the gap pipe to the thinner and hence the air gap is smaller.

In one embodiment the adhering is selected from adhesives, mechanical interlocking, laser welding, gas torch welding, ultrasonic joining, centrifugal casting and injection moulding.

In one embodiment, the gap pipe may be bonded to the stator using heat and/or pressure to melt the plastic at the interface with the stator to create micro and/or macro mechanical adhesion.

In one embodiment, the gap pipe may be bonded to the stator by overmolding the gap pipe directly onto the stator component or stator assembly.

In one embodiment, the stator laminations may be surface treated prior to the gap pipe being mechanically adhered. The surface treatment may include chemical etching processes, mechanical treatment, and/or other surface activation methods.

The gap pipe may be made by any known technique. It may be made from tapes comprising plastic and fibres. It may be made via a mandril and an automatic tape placement or filament winding machine. The tapes may be consolidated in situ to form the gap pipe.

In a further aspect of the invention, there is provided use of a gap pipe to reduce the air gap in an electric motor comprising a rotor and a stator, wherein the rotor and stator are as described herein.

Electric motor assembly

In one aspect of the invention there is provided, an electric motor assembly comprising;

a rotor comprising a rotor core and a rotor sleeve which circumferentially encloses the rotor core, wherein the rotor core comprises one or more magnets, wherein the rotor sleeve comprises a plastic and fibres, wherein the fibres have a tensile strength greater than or equal to 4440 MPa; and a stator comprising a gap pipe, wherein the gap pipe comprises a plastic and fibres, wherein the fibres have a tensile strength greater than or equal 4440 MPa and dry fibre tensile modulus in the range of 200 to 450 GPa;

and wherein an air gap is provided between the rotor sleeve and the gap pipe.

The rotor may have any of the optional features described above.

The stator may have any of the optional features described above.

The electric motor may be any type of electric motor.

The term “air gap” is well understood in the field. It is defined as the space between the magnetised components of the rotor (e.g the one or more magnets in the rotor core) and the stator laminations. The inventors have discovered that the combined use of a gap pipe for the stator and a rotor sleeve for the rotor, as described herein, leads to a significant reduction in the air gap. This results in improved motor efficiency. The rotor sleeve and gap pipe as described herein form part of the air gap, but by using a plastic and fibres with the claimed tensile strength and/or dry tensile modulus, it is possible to make the rotor sleeve and gap pipe thinner. Due to the rigid nature of the rotor sleeve and gap pipe, deflection of parts of the electric motor during use is reduced, and thus the mechanical gap (i.e. the space between the rotor sleeve and the gap pipe) can be significantly reduced.

In one embodiment, the air gap has a distance of 0.9 mm to 5.5 mm, preferably 1.1 mm to 3 mm.

In one embodiment, the gap pipe has a thickness of 0.3 mm to 3 mm; the rotor sleeve has a thickness of 0.3 mm to 2 mm and the air gap has a distance of 0.9 mm to 5.5 mm.

In one embodiment, the electromagnetic separation of the yoke and pole in the rotor core, enabled by the rotor sleeve, increased the simulated torque output of an electric motor by 21% through reduced leakage flux and increased reluctance torque. In another embodiment the combination of a gap pipe and rotor sleeve further increased the maximum power output of an electric motor by 22% and the maximum efficiency by 0.5%. In another embodiment a gap pipe enabled increased continuous motor torque by 30% and continuous motor power by 40% as compared to a water jacked cooled motor of similar size and mass.

In one embodiment, the electric motor is designed to operate at a motor speed in the range of 20,000 rpm to 45,000 rpm, preferably 25,000 rpm to 40,000 rpm, more preferably 30,000 rpm to 40,000 rpm.

### Vehicle

In one aspect of the invention, there is provided a vehicle comprising an electric motor assembly comprising;
a rotor comprising a rotor core and a rotor sleeve which circumferentially encloses the rotor core, wherein the rotor core comprises one or more magnets, wherein the rotor sleeve comprises a plastic and fibres, wherein the fibres have a tensile strength greater than or equal to 4440 MPa; and
a stator comprising a gap pipe, wherein the gap pipe comprises a plastic and fibres, wherein the fibres have a tensile strength greater than or equal 4440 MPa and dry fibre tensile modulus in the range of 200 to 450 GPa;
and wherein an air gap is provided between the rotor sleeve and the gap pipe.

In one embodiment, the vehicle may be selected from light passenger vehicles, high performance vehicles, cars, trucks, buses, or trains.

### DETAILED DESCRIPTION OF THE FIGURES

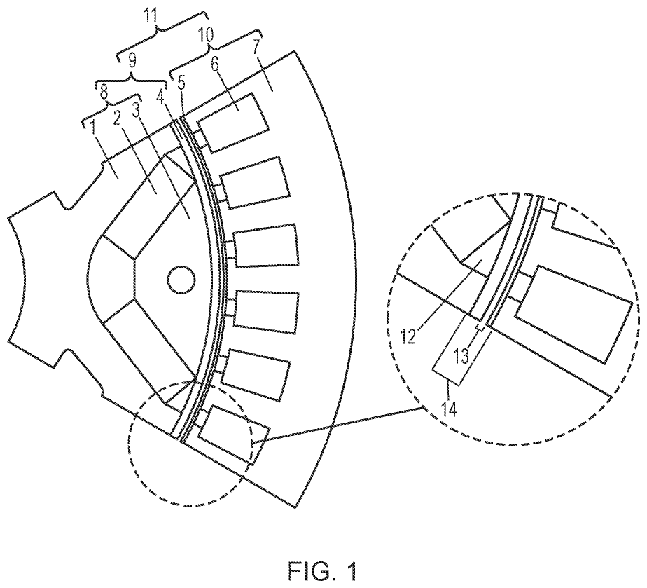

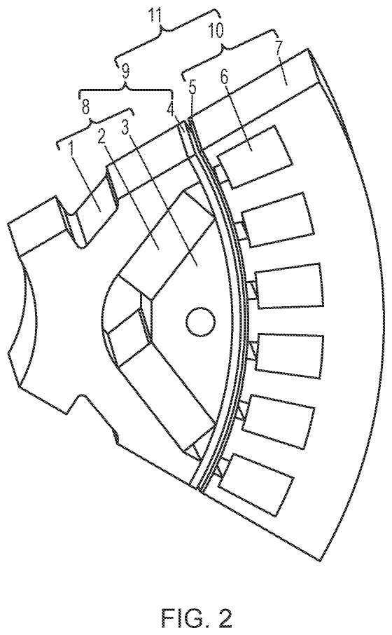

FIGS. 1 and 2 show a cross section of an electric motor 11 comprises a rotor 9 and stator 10 according to one embodiment of the invention. The rotor 9 comprises a rotor yoke 1, magnets 2 and a pole 3. These form the rotor core 8. There are two performance categories for which the rotor core geometry must accommodate, mechanical and electromagnetic. The rotor 9 must have sufficient strength to withstand high rotational speed and torque transmission through the yoke. Simultaneously, the rotor core 8 must be structured to optimize the electromagnetic field geometry for motor effectiveness. One purpose of the rotor sleeve 4 is to mitigate the trade-off between mechanical and electromagnetic geometry by supplementing the mechanical loading of the rotor core 8 with a rotor sleeve 4 thereby enabling more preferential electromagnetic configurations of the rotor core 8 leading to increased efficiency and/or power of the electric motor 11. The magnets 2 may be permanent magnets. The rotor yoke 1 and poles 3 may be made from electrically conductive material, such as steel. The rotor 9 comprises a rotor sleeve 4 which circumferentially encloses the rotor core. The rotor sleeve 4 comprises a plastic and fibres, wherein the fibres have a tensile strength greater than or equal to 4440 MPa.

The stator 10 comprises stator windings 6, stator laminations 7 and a gap pipe 5. Commonly, the sustained operational limit of a stator is thermally bounded below the instantaneous maximum power output of the motor. Therefore, the applied motor power output and efficiency in application can be greatly impacted by thermal management of the stator. One preferred method of stator cooling is oil cooling of the stator winding. This can lead to hydrodynamic losses when the oil coolant is in contact with the rotor 9. The purpose of the gap pipe 5 is to separate the stator 10 and the rotor 9. The gap pipe 5 comprises a plastic and fibres, wherein the fibres have a tensile strength greater than or equal 4440 MPa and dry fibre tensile modulus in the range of 200 to 450 GPa.

The air gap 14 is shown in the zoomed in section of FIG. 1. The air gap is the space between the rotor magnetised components (rotor yoke 1, magnets 2 and poles 3) and the stator laminations 7. This distance should be minimised to maximise electromagnetic efficiency. FIG. 1 also shows the mechanical gap 13, which is the running clearance between the rotor sleeve 4 and the gap pipe 5. This is required for mechanical efficiency and to prevent binding. FIG. 1 also shows an electromagnetic air pocket 12.

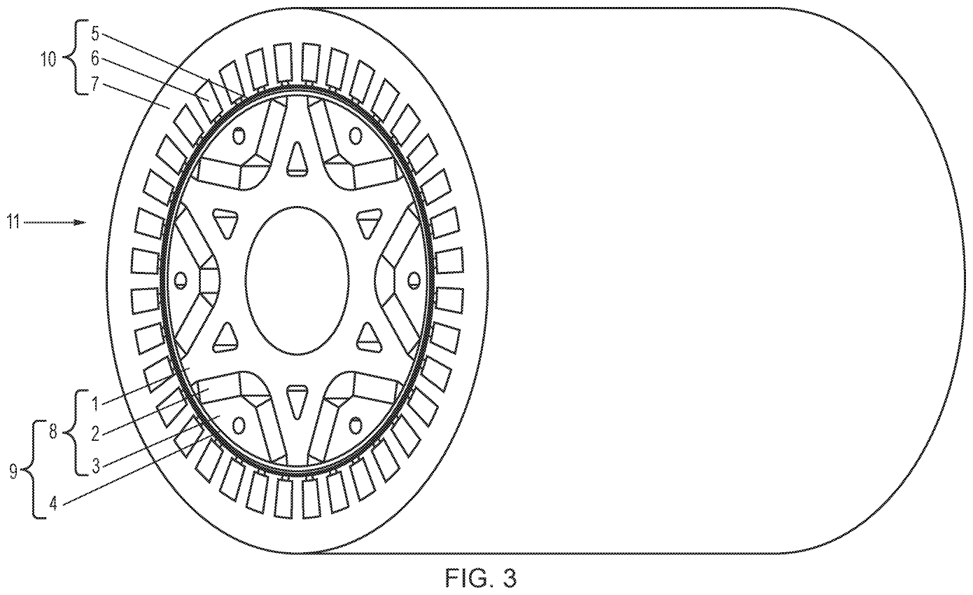

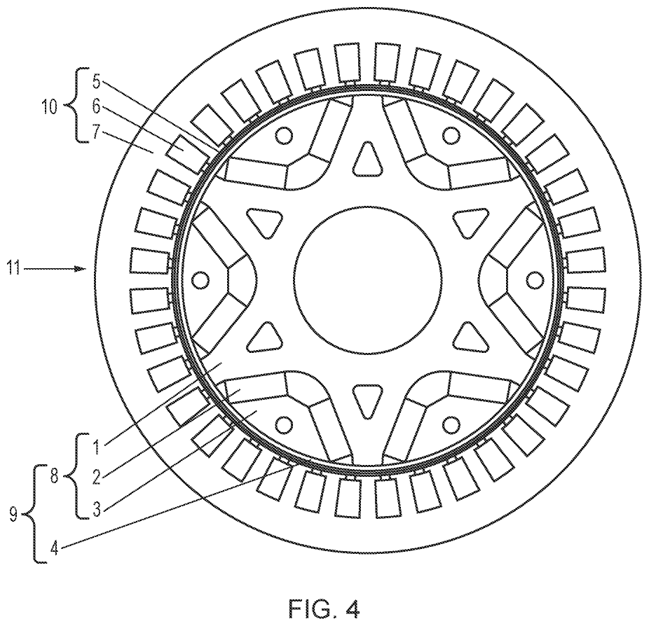

FIG. 3 shows a side view of an electric motor 11 comprises a rotor 9 and stator 10 according to one embodiment of the invention. The stator 10 is cylindrical and comprises a plurality of windings 6 around its circumference. The stator 10 has a hollow centre, in which the rotor 9 is retained. The rotor 9 comprises a plurality of magnets 2 and poles 3 within the rotor core 8. FIG. 4 shows a face on view of the electric motor 11 in FIG. 3.

### EXAMPLES

### Example 1

In Example 1, a 2D analytical model treating the rotor sleeve as a simplified thin-walled pipe in combination with a linear elastic finite element model (FEM: Altair Hyperworks) was used for comparative analysis of the rotor sleeve while a linear elastic composite finite element model was used for comparative analysis of the gap pipe. The results are shown in Tables 1 and 2.

TABLE 1
Rotor Sleeve

| | Fibre Tensile | Fibre | Rotor Sleeve | |
|---|---|---|---|---|
| | Strength | Modulus | thickness | Air Gap |
| Rotor Sleeve Test | (MPa) | (GPa) | (mm) | (mm) |
| Test 1 | 4447 | 231 | 1.350 | 1.779 |
| Test 2 | 4800 | 241 | 1.322 | 1.692 |
| Test 3 | 5600 | 276 | 1.236 | 1.503 |
| Test 4 | 6800 | 313 | 1.162 | 1.286 |
| Test 5 | 6900 | 331 | 1.130 | 1.264 |
| Comparative Test A | 3450 | 72.4 | 2.381 | 2.530 |

As can be seen from the results in Table 1, a rotor sleeve according to the present invention, comprising fibres having a tensile strength above 4440 MPa results in a reduced air gap.

TABLE 2
Gap Pipe

| | Fibre Tensile | Fibre | Gap pipe | |
|---|---|---|---|---|
| | Strength | Modulus | thickness | Air Gap |
| Gap Pipe Test | (MPa) | (GPa) | (mm) | (mm) |
| Test 6 | 4447 | 231 | 0.978 | 0.9837 |
| Test 7 | 4930 | 243 | 0.978 | 0.9829 |
| Test 8a | 5688 | 276 | 0.978 | 0.9824 |
| Test 8b | 5688 | 276 | 0.838 | 0.8431 |
| Test 8c | 5688 | 276 | 0.699 | 0.7044 |
| Test 8d | 5688 | 276 | 0.559 | 0.5662 |
| Test 9a | 6826 | 313 | 0.978 | 0.9819 |
| Test 9b | 6826 | 313 | 0.838 | 0.8425 |
| Test 9c | 6826 | 313 | 0.699 | 0.7037 |
| Test 9d | 6826 | 313 | 0.559 | 0.5653 |
| Comparative Test B | 4400 | 240 | 0.978 | 0.9853 |
| Comparative Test C | 3450 | 72.4 | 0.978 | 0.9958 |

As can be seen from the results in Table 2, a gap pipe according to the present invention, comprising fibres having a tensile strength above 4440 MPa and a dry tensile modulus in the range of 200 to 450 GPa results in a reduced air gap.

### Example 2

In Example 2, a 2D analytical-numerical model (AVL simulation tool chain for electromagnetic design AVL eSUITE™) simulating the benefits of particular embodiments of the rotor sleeve and gap pipe versus a baseline motor configuration of a Permanent Magnet Synchronous Motor (PMSM) with water jacket cooling (‘Baseline’ in Table 3) was used. The following benefits in Table 3 were identified, indexed against the baseline.

TABLE 3
Performance Simulation Benefits

| | Prior Art Embodiment | Invention | Invention |
|---|---|---|---|
| | (Baseline) | embodiment 1 | embodiment 2 |
| Cont. Torque | Baseline | +30% | +30% |
| Cont. Power | Baseline | +40% | +40% |
| Max Power | Baseline | +0% | +25% |
| Efficiency | Baseline | +5% | +5.5% |

Invention embodiment 1: baseline motor with direct stator cooling using a gap pipe according to the invention approximating Test 8d in Table 2 above instead of the baseline water jacket.

Invention embodiment 2: motor as per Invention embodiment 1 with the addition of rotor sleeve according to the invention approximating Test 3 in Table 1 above.

Through additional simulation scenarios it was found that for each 1 mm of air gap reduction there was typically a corresponding increase in efficiency of 1%.

Further optimizations are expected due system design changes that reflect and optimize the duty cycle of a specific vehicle platform.

### Example 3

In Example 3, two configurations of gap pipes according to the invention were manufactured.

Configuration 1: a PAEK resin gap pipe with a thickness of 0.4 mm; a fibre modulus of 240 GPa and a fibre tensile strength of 4440 MPa. This was manufactured using industry standard thermoplastic composite manufacturing methods, specifically Automated Fibre Placement-AFP.

Configuration 2: a PAEK resin gap pipe with a thickness of 0.8 mm; a fibre modulus of 240 GPa and a fibre tensile strength of 4440 MPa. This was manufactured using industry standard thermoplastic composite manufacturing methods, specifically Automated Fibre Placement-AFP.

In this example, it was surprisingly found that the reduced thickness improved quality as measured by uniformity of the outer diameter. It was found that the tolerance stack could be reduced by approximately 40% resulting in a thinner product that still retains impermeable properties due to the presence of the PAEK resin and fibre distribution.

The thinner gap pipe as manufactured above with higher dimensional quality will enable:
Improved assembly efficiency and robustness
Reduced scrap and waste
Increased manufacturing throughput
Reduced environmental footprint

This also impacts the overall size of the inner surface of the gap pipe whereby further benefits as articulated in Example 2 Table 3 may be realised.

1. A rotor for an electric motor, wherein the rotor comprises a rotor core and a rotor sleeve which circumferentially encloses the rotor core, wherein the rotor core comprises one or more magnets, wherein the rotor sleeve comprises a plastic and fibres, wherein the fibres have a tensile strength greater than or equal to 4440 MPa.

2. The rotor according to claim 1, wherein the fibres are selected from carbon fibres, aramid fibres or glass fibres.

3. The rotor according to claim 1, wherein the fibres have a tensile strength greater than or equal to 5000 MPa.

4. The rotor according to claim 1, wherein the fibres have a dry fibre tensile modulus in the range of 200 to 450 GPa.

5. (canceled)

6. (canceled)

7. The rotor according to claim 1, wherein the rotor sleeve has a thickness of less than 2.5 mm.

8. The rotor according to claim 1, wherein the rotor sleeve comprises between 30% and 70% by volume of fibre.

9. The rotor according to claim 1, wherein the plastic is a thermoplastic, wherein the thermoplastic comprises a polyaryletherketone (PAEK).

10. The rotor according to claim 1, wherein the rotor sleeve has a pre-tension between 10% and 60% of the rotor sleeve tensile strength.

11. A method for producing a rotor comprising a rotor core and a rotor sleeve, the method comprising the steps of:
providing a rotor core comprising one or more magnets;
providing a material comprising a plastic and fibres, wherein the fibres have a tensile strength greater than or equal to 4440 MPa;
winding the material around the rotor core such that the material is tensioned and forms a rotor sleeve which circumferentially encloses the rotor core.

12. The method according to claim 11, wherein the material is a fibre, filament, tape, sheet or ribbon.

13. A stator for an electric motor comprising a gap pipe, wherein the gap pipe comprises a plastic and fibres, wherein the fibres have a tensile strength greater than or equal to 4440 MPa and dry fibre tensile modulus in the range of 200 to 450 GPa.

14. The stator according to claim 13, wherein the fibres are selected from carbon fibres, aramid fibres or glass fibres.

15. The stator according to claim 13, wherein the fibres have a tensile strength greater than or equal to 5000 MPa.

16. The stator according to claim 13, wherein the fibres have a dry fibre tensile modulus in the range of 240 to 350 GPa.

17. (canceled)

18. (canceled)

19. The stator according to claim 13, wherein the gap pipe has a thickness between 0.3 mm and 3 mm.

20. The stator according to claim 13, wherein the gap pipe comprises between 30 and 70% by volume of fibre.

21. The stator according to claim 13, wherein the plastic is a thermoplastic, wherein the thermoplastic comprises a polyaryletherketone (PAEK).

22. A method for producing a stator comprising laminations and a gap pipe, the method comprising the steps of:
providing a stator comprising laminations;
providing a gap pipe comprising a plastic and fibres, wherein the fibres have a tensile strength greater than or equal to 4440 MPa and dry fibre tensile modulus in the range of 200 to 450 GPa; and
adhering the gap pipe to the stator laminations.

23. (canceled)

24. An electric motor assembly comprising;
a rotor comprising a rotor core and a rotor sleeve which circumferentially encloses the rotor core, wherein the rotor core comprises one or more magnets, wherein the rotor sleeve comprises a plastic and fibres, wherein the fibres have a tensile strength greater than or equal to 4440 MPa; and
a stator comprising a gap pipe, wherein the gap pipe comprises a plastic and fibres, wherein the fibres have a tensile strength greater than or equal 4440 MPa and dry fibre tensile modulus in the range of 200 to 450 GPa;
and wherein an air gap is provided between the rotor sleeve and the gap pipe.

25. A vehicle comprising the assembly according to claim 24.
